(19) United States
(12) Patent Application Publication
(10) Pub. No.: US 2017/0200556 A1
(43) Pub. Date: Jul. 13, 2017

(54) ELECTRIC COMPONENT

(71) Applicant: E I DU PONT DE NEMOURS AND COMPANY, Wilmington, DE (US)

(72) Inventor: Akira INABA, Kawasaki-Shi (JP)

(21) Appl. No.: 14/992,427

(22) Filed: Jan. 11, 2016

(51) Int. Cl. H01G 4/008; H01G 4/248; H01G 4/30

(52) U.S. Cl. CPC H01G 4/0085; H01G 4/30; H01G 4/248

(57) ABSTRACT

The present invention relates to an electric component comprising a main body, a terminal electrode on at least one side of the main body and a hot-melt polymer layer on the terminal electrode, wherein the hot-melt polymer layer comprises a metal powder, a polymer and a wax.

### FIELD OF THE INVENTION

The present invention relates to an electric component and a method of manufacturing thereof.

### TECHNICAL BACKGROUND OF THE INVENTION

An electric component is mounted on a circuit by using a solder. The solder needs to smoothly spread out on a terminal electrode of the electric component. The solder layer having voids could negatively affect electrical properties of the electric component.

EP0720187 discloses a multiple-layered capacitor having a terminal electrode that is made of a composition containing a silver particle, a glass frit having a glass transition point of 400-500° C. and a glass softening point of 400-550° C., and an organic vehicle.

### BRIEF SUMMARY OF THE INVENTION

An objective is to provide an electric component to be soldered with few voids.

An aspect of the invention relates to an electric component comprising a main body, a terminal electrode on at least one side of the main body and a hot-melt polymer layer on the terminal electrode, wherein the hot-melt polymer layer comprises a metal powder, a polymer and a wax.

Another aspect of the invention relates to a method of manufacturing an electric component comprising steps of: providing a main body of the electric component comprising a terminal electrode formed on at least one side of the main body; applying a hot-melt polymer paste on the terminal electrode, wherein the hot-melt polymer paste comprises a metal powder, a polymer, a wax and a solvent; and drying the applied hot-melt polymer.

An electric component being soldered with few voids can be provided by the present invention.

### BRIEF DESCRIPTION OF DRAWINGS

FIG. 1 is a schematic cross-sectional drawing of the electric component.

FIG. 2 is a schematic cross-sectional drawing of the electrical device before soldering.

FIG. 3 is a schematic cross-sectional drawing of the electric component after soldering.

FIG. 4 is a side view of a test piece of the electric component used in the Example.

### DETAILED DESCRIPTION OF INVENTION

An electric component and a method of soldering the electric component are explained below.

### Electric Component

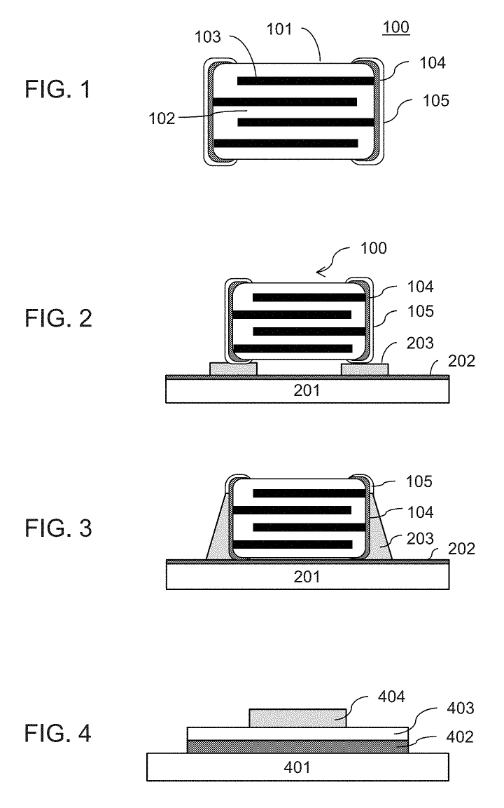

An electric component 100 as a capacitor is shown in FIG. 1. The capacitor 100 comprises a main body 101, terminal electrodes 104 on both sides of the main body, and hot-melt polymer layers 105 on the terminal electrodes in an embodiment. The terminal electrode 104 is defined as an electrode electrically and physically joined with an external conductive element such as a circuit. The main body 101 of the capacitor is a laminate comprising insulating ceramic layers 102 and internal electrodes 103 in an embodiment.

The terminal electrode 104 can be a fired-type electrode or a cured-type electrode in an embodiment. The fired-type electrode can be formed by applying a conductive paste comprising typically a conductive powder, a glass frit and an organic vehicle; and firing the conductive paste in an embodiment. The firing temperature is 400 to 1000° C. in an embodiment.

The cured-type electrode can be formed by applying a heat-curable conductive paste comprising typically a conductive powder and a thermosetting polymer; and curing the heat-curable conductive paste in an embodiment. The curing temperature is 120 to 390° C. in an embodiment. The conductive powder can be selected from the group consisting of silver, gold, platinum, copper, nickel and a mixture thereof in another embodiment. The terminal electrode 104 is 5 to 100 μm thick in an embodiment.

The hot-melt polymer layer 105 is formed on the terminal electrodes 104. The hot-melt polymer layer 105 melts at a reflow temperature. Reflow is a heating process to solder the electric component and the circuit. The hot-melt polymer layer 105 is 1 to 30 μm thick in an embodiment, 3 to 25 μm thick in another embodiment and 5 to 15 μm thick in another embodiment.

The hot-melt polymer layer 105 comprises a metal powder, a polymer and a wax. The hot-melt polymer layer 105 comprises no glass frit in an embodiment. The hot-melt polymer layer 105 comprises no cross-linking agent in another embodiment.

The method of manufacturing the electric component comprises steps of, providing an electric component comprising a main body and a terminal electrode on at least one side of the main body, applying a hot-melt polymer paste on the terminal electrode, and drying the applied hot-melt polymer paste. The hot-melt polymer layers 105 can be applied on the terminal electrode 104 by for example dipping, screen printing and transfer printing in an embodiment. The applied hot-melt polymer paste is then dried out to remove the solvent. The drying temperature can be 50 to 200° C. in an embodiment, 60 to 180° C. in another embodiment, 90 to 160° C. in another embodiment.

The hot-melt polymer layer 105 can be partially formed on the terminal electrode 104 in another embodiment. The hot-melt polymer layer 105 can be formed on the terminal electrode at least at the area of contingence with a solder paste as being mounted thereon. At least 70% of the surface of the terminal electrode 104 can be covered with the hot-melt polymer layer 105 in another embodiment. The hot-melt polymer layer 105 can be formed on the entire surface of the terminal electrode 104 in another embodiment.

In another embodiment, the terminal electrode can be only one side of the main body. The electric component can comprise a main body, a terminal electrode on just one side of the main body and a hot-melt polymer layer on the terminal electrode in another embodiment. The terminal electrode can be formed on a bottom surface of the main body 101 in another embodiment. The bottom surface of the main body is the side facing the circuit in another embodiment.

The electric component 100 is mounted on an electric circuit board as shown in FIG. 2 in an embodiment. The electric circuit board comprises a substrate 201 and a circuit 202 on the surface of the substrate in an embodiment. The substrate 201 can be rigid or flexible in an embodiment. The substrate 201 can be a paper phenol substrate, a paper epoxy substrate, a glass epoxy substrate, a ceramic substrate, a low temperature co-fired ceramic (LTCC) substrate, a polymer film, a glass substrate, a ceramic substrate or a combination thereof in another embodiment. The circuit 202 can be made with a plated metal, a metal foil or a thick film conductive paste in an embodiment.

A solder paste 203 is applied on the circuit 202 in an embodiment. The solder paste 203 comprises a solder powder and a flux in an embodiment. The solder powder is a metal alloy containing a metal having low melting point. The solder paste 203 comprises a solder powder selected from the group consisting of Sn/Pb, Sn/Pb/Bi, Sn/Sb, Sn/Cu, Sn/Ag/Cu, Sn/Zn/Bi, Sn/Zn/Al, Sn/Ag/In/Bi and Sn/Ag/Cu/Ni and a mixture thereof in an embodiment.

The solder paste 203 is lead-free in another embodiment. A lead-free solder is environment-friendly, however often causes less solderability compared to a lead-containing solder. The electric component of the present invention could have sufficient solderability even in use of a lead-free solder paste.

The solder paste is purchasable in the market, for example, Eco Solder® from Senju Metal Industry Co., Ltd., Evasol® from Ishikawa Metal Co., Ltd. and Fine Solder® from Matsuo Handa Co., Ltd.

The electric component 100 is mounted on the solder paste 203 as the hot-melt polymer layers 105 come thereon as shown in FIG. 2 in an embodiment.

The assembly is then heated, so-called “reflow” where the solder melts by the heat to electrically and physically connect the electric components 100 and the circuit 202. Heating may be accomplished by passing the assembly through a reflow oven or under an infrared lamp or by soldering individual joints with a hot air pencil.

The reflow temperature is 100 to 350° C. in an embodiment, 150 to 310° C. in another embodiment, 200 to 290° C. in another embodiment. The reflow time is 1 to 60 second(s) in an embodiment, 4 to 30 seconds in another embodiment, and 6 to 20 seconds in another embodiment. The heating temperature and time are adjustable in consideration of their combination such as low temperature for long time and high temperature for short time.

The solder paste 203 melts to spread out upward on the terminal electrodes 104 as fusing the hot-melt polymer layer during the reflow as shown in FIG. 3. The metal powder in the hot-melt polymer layer 105 could melt into an alloy with the molten solder 203. The polymer in the hot-melt polymer layer could move away as the molten solder spread out on the terminal electrode due to its higher specific gravity. The specific gravity of the solder is 7 to 10 g/cm³ in an embodiment. The specific gravity of the polymer is 0.8 to 2.0 in an embodiment.

The electric component 100 can be selected from the group consisting of a resistor, a capacitor, an inductor and a semiconductor chip in an embodiment.

The hot-melt polymer paste to form the hot-melt polymer layer is explained hereafter. The hot-melt polymer paste comprises a metal powder, a polymer, a wax and a solvent.

### Metal Powder

The metal powder can be selected from the group consisting of silver, copper, gold, palladium, platinum, rhodium, nickel, aluminum, gallium, indium, tin, zinc, bismuth and a mixture thereof in an embodiment. The metal powder can be selected from the group consisting of silver, nickel, tin, zinc, bismuth and a mixture thereof in another embodiment. The metal powder can be silver in another embodiment.

The metal powder can be flaky, spherical, nodular or a mixture thereof in shape in an embodiment. The metal powder can be flaky in shape in another embodiment. The metal powder can be spherical in shape in another embodiment.

The particle diameter (D50) of the metal powder can be 0.5 to 20 μm in an embodiment, 0.7 to 15 μm in another embodiment, 0.9 to 10 μm in another embodiment, 1 to 5 μm in another embodiment, 0.5 to 2 μm in another embodiment, 3 to 5 μm in another embodiment. The metal powder with such particle size can disperse well in the organic vehicle. The particle diameter (D50) is obtained by measuring the distribution of the powder diameters by using a laser diffraction scattering method with Microtrac model X-100.

### Polymer

The hot-melt polymer layer comprises a polymer. The metal powder disperses in the polymer. The polymer is soluble at 25° C. in an organic solvent used in the hot-melt polymer paste.

Glass transition point (Tg) of the polymer is −25 to 180° C. in an embodiment, 10 to 168° C. in another embodiment, 120 to 180° C. in another embodiment, 10 to 50° C. in another embodiment. The polymer starts alternating rigid crystalline and elastic amorphous regions at its glass transition point.

Molecular weight (Mw) of the polymer is 500 to 300,000 in an embodiment, 10,000 to 260,000 in another embodiment, 13,000 to 230,000 in another embodiment, 50,000 to 200,000 in another embodiment, and 100,000 to 190,000 in another embodiment.

The polymer can be selected from the group consisting of ethyl cellulose, polyvinyl butyral resin, phenoxy resin, hydroxypropyl cellulose resin, polyester resin, phenolic resin, epoxy resin, acrylic resin, melamine resin, polyimide resin, polyamide resin, polystyrene resin, butyral resin, polyvinyl alcohol, polyurethane resin, silicone resin and a mixture thereof in an embodiment. The polymer can be selected from the group consisting of ethyl cellulose, polyvinyl butyral resin, phenoxy resin, polyester resin, epoxy resin and a mixture thereof in another embodiment. The polymer comprises ethyl cellulose in another embodiment. The hot-melt polymer paste comprises no thermosetting polymer in another embodiment.

The polymer is thermoplastic in an embodiment.

The polymer is 0.5 to 20 parts by weight in another embodiment, 1 to 15 parts by weight in another embodiment, 1.5 to 10 parts by weight in another embodiment, 2 to 7 parts by weight in another embodiment against 100 parts by weight of the metal powder.

### Wax

Wax is a type of lipid that is malleable at 20° C. and turn to liquid at between 30 and 300° C. Melting point of the wax is 30 and 300° C. in another embodiment. The wax is selected from the group consisting of vegetable wax, animal wax, mineral wax, petroleum wax, synthetic wax and a mixture thereof in another embodiment.

The vegetable wax is selected from the group consisting of bayberry wax, candelilla wax, carnauba wax, castor oil, esparto wax, jojoba oil, ouricury wax, rice bran wax, soy wax, tallow tree wax and a mixture therefor.

The animal wax is selected from the group consisting of beeswax, wool wax, shellac wax, spermaceti and a mixture thereof in another embodiment.

The mineral wax is selected from the group consisting of ceresin wax, montan wax, montan-ester wax, paraffin wax, microcrystalline wax, ozocerite wax, peat wax and a mixture thereof in another embodiment.

The petroleum wax is selected from the group consisting of paraffin wax, microcrystalline wax, petroleum jelly and a mixture thereof in another embodiment.

The synthetic wax is selected from the group consisting of fischer-tropsch wax, polyethylene wax, polyolefin wax, polypropylene wax, amide wax, hydrogenated oil, fatty acid wax, fatty acid ester wax and a mixture thereof. The fatty acid wax is stearic acid in an embodiment.

The wax is selected from the group consisting of bayberry wax, candelilla wax, carnauba wax, castor oil, esparto wax, jojoba oil wax, ouricury wax, rice bran wax, soy wax, tallow tree wax, beeswax, wool wax, shellac wax, spermaceti, ceresin wax, montan wax, montan-ester wax, paraffin wax, microcrystalline wax, ozocerite wax, peat wax, paraffin wax, microcrystalline wax, petroleum jelly wax, fischer-tropsch wax, polyethylene wax, polyolefin wax, polypropylene wax, amide wax, fatty acid wax, fatty acid ester wax and a mixture thereof in another embodiment.

The wax is selected from the group consisting of castor oil, montan wax, montan-ester wax, polyethylene wax, polypropylene wax, amide wax, fatty acid wax and a mixture thereof in another embodiment.

The wax is 0.1 to 50 parts by weight in an embodiment, 1 to 38 parts by weight in another embodiment, 2 to 15 parts by weight in another embodiment.

### Solvent

The solvent can be used to dissolves the polymer. The solvent evaporates during drying out the hot-melt polymer paste on the terminal electrode.

The solvent is 2 to 60 parts by weight in an embodiment, 9 to 50 parts by weight in another embodiment, 15 to 40 parts by weight in another embodiment against 100 parts by weight of the metal powder.

Boiling point of the solvent can be 120 to 350° C. in an embodiment, 160 to 320° C. in another embodiment, 200 to 290° C. in another embodiment.

The solvent can be an organic solvent in an embodiment.

The solvent can be selected from the group consisting of texanol, 1-phenoxy-2-propanol, terpineol, carbitol acetate, ethylene glycol, butyl carbitol, dibutyl carbitol, dibuthyl acetate propylene glycol phenyl ether, ethylene glycol monobutyl ether and a mixture thereof in another embodiment.

The solvent can be used to adjust the viscosity of the hot-melt polymer paste to be preferable for applying on the substrate. Viscosity of the polymer paste is 10 to 300 Pa·s measured by Brookfield HBT with a spindle #14 at 10 rpm in an embodiment. In the event of dipping, the viscosity of the conductive paste can be 10 to 120 Pa·s.

### Additive

An additive such as a surfactant, a dispersing agent, a stabilizer and a plasticizer can be added to the polymer paste based on a desired property of the paste.

### Example

The present invention is illustrated by, but is not limited to, the following examples.

The hot-melt polymer paste was prepared as follows.

A spherical silver powder was dispersed in a mixture of an ethyl cellulose (Mw: about 180,000, Tg: 130° C., Ethocel® STD-100, Dow Chemical Company), a solvent, and a polypropylene wax (CERAFLOUR® 970, BYK-Chemie Japan) by mixing well in a mixer followed by a three-roll mill until the metal powder was dispersed well. The polypropylene wax was a synthetic wax. The solvent was a mixture of texanol and 1-Phenoxy-2-propanol. The paste viscosity was adjusted by adding the solvent to about 30 Pas measured by Brookfield HBT with a spindle #14 at 50 rpm. Particle diameter (D50) of the silver powder was 1.3 μm. The amount of each material is shown in Table 1.

The hot-melt polymer layer prepared above was screen printed on the cured-type electrode 402 formed on a ceramic substrate 401 as shown in FIG. 4. The cured-type electrode 402 was prepared in advance, formed by screen printing a heat-curable conductive paste on the ceramic substrate 401 followed by heating at 170° C. for 30 minutes. The cured-type electrode consisted of 91 wt. % of a copper powder and 9 wt. % of a phenolic resin. The cured-type electrode 402 was a square of 12 mm wide, 25 mm long, 22 μm thick. The printed hot-melt polymer paste 403 was heated at 120° C. for 30 minutes, thereby the solvent in the paste evaporated. The hot-melt polymer layer 403 was a square of 12 mm wide, 25 mm long and 15 μm thick.

A Pb-free solder paste 404 (Sn/Ag/Cu=96.5/3/0.5, M705, Senju Metal Industry Co., Ltd.) was screen printed on the hot-melt polymer layer 403. The pattern of the solder paste 404 was a circle of 6 mm diameter and 200 μm thick.

The ceramic substrate with the layers of the electrode, the hot-melt paste and the solder paste was placed on a hot-plate to reflow at 240° C. for 30 seconds. During the reflow, the solder paste melted to spread out on the electrode.

After cooling down to room temperature, number of void appeared in solder layer at a unit area of 1 mm² was visually counted.

The void decreased when the hot-melt paste contained the wax as Example (Ex.) 1 to 6 showed in comparison of Comparative Example (Com. Ex.) 1. Sufficient solderability with spreading out was observed in all Examples and Comparative Example.

TABLE 1
(Parts by weight)

| | Com. | | | | | | |
|---|---|---|---|---|---|---|---|
| | Ex. 1 | Ex. 1 | Ex. 2 | Ex. 3 | Ex. 4 | Ex. 5 | Ex. 6 |
| Ag Powder | 100 | 100 | 100 | 100 | 100 | 100 | 100 |
| Ethyl | 5 | 5 | 5 | 5 | 5 | 5 | 2.5 |
| cellulose | | | | | | | |
| resin | | | | | | | |
| Solvent | 75 | 75 | 75 | 75 | 75 | 75 | 52.5 |
| Polypropylene | 0 | 3 | 6 | 10 | 15 | 30 | 10 |
| wax | | | | | | | |
| Voids | 8.8 | 0.7 | 0.3 | 0.3 | 2.8 | 3.3 | 0.9 |

Next, the variety of wax was examined. The ceramic substrate with the layers of the electrode, the hot-melt paste and the solder paste was formed in the same manner as Example 1 above except for using different kind of wax as shown in Table 2. The amide wax, the polyethylene wax, the polypropylene wax, and the fatty acid wax are synthetic waxes. The castor oil is a vegetable wax. The montan wax and the montan-ester wax are mineral waxes.

The void on the solder layer was counted as well as Example 1. With any kind of wax, the void appeared less as shown in Example 7 to 13.

TABLE 2
(Parts by weight)

| | Ex. 7 | Ex. 8 | Ex. 9 | Ex. 10 | Ex. 11 | Ex. 12 | Ex. 13 |
|---|---|---|---|---|---|---|---|
| Ag Powder | 100 | 100 | 100 | 100 | 100 | 100 | 100 |
| Ethyl | 5 | 5 | 5 | 5 | 5 | 5 | 5 |
| cellulose | | | | | | | |
| resin | | | | | | | |
| Solvent | 75 | 75 | 75 | 75 | 75 | 75 | 75 |
| Amide wax¹⁾ | 10 | 0 | 0 | 0 | 0 | 0 | 5 |
| Castor oil²⁾ | 0 | 10 | 0 | 0 | 0 | 0 | 0 |
| Montan | 0 | 0 | 10 | 0 | 0 | 0 | 0 |
| wax³⁾ | | | | | | | |
| Montan-ester | 0 | 0 | 0 | 10 | 0 | 0 | 0 |
| wax⁴⁾ | | | | | | | |
| Polyethylene | 0 | 0 | 0 | 0 | 10 | 0 | 0 |
| wax⁵⁾ | | | | | | | |
| Fatty acid | 0 | 0 | 0 | 0 | 0 | 10 | 0 |
| wax⁶⁾ | | | | | | | |
| Polypropyl- | 0 | 0 | 0 | 0 | 0 | 0 | 5 |
| ene wax⁷⁾ | | | | | | | |
| Voids | 0 | 2.1 | 0.2 | 0.6 | 0.3 | 0.9 | 0.2 |

¹⁾CERAFLOUR ® 994, BYK-Chemie Japan K.K.
²⁾DISPARLON ® 308, Kusumoto Kasei Co. Ltd.
³⁾Licowax ® LP, Clariant Ltd.
⁴⁾Licowax ® E, Clariant Ltd.
⁵⁾Licowax ® R21, Clariant Ltd.
⁶⁾Stearic acid, Wako Pure Chemical Industries Ltd.
⁷⁾CERAFLOUR ® 970, BYK-Chemie Japan K.K.

Next, variety of the polymer was examined. The ceramic substrate with the layers of the electrode, the hot-melt paste and the solder paste was formed in the same manner as Example 1 above except for using different kinds of polymers as shown in Table 3. The void was counted as well as Example 1. With all kinds of polymer, the void appeared less than six as shown in Example 14 to 16.

TABLE 3
(Parts by weight)

| | Ex. 14 | Ex. 15 | Ex. 16 |
|---|---|---|---|
| Ag Powder | 100 | 100 | 100 |
| Solvent | 65 | 40 | 54 |
| Polypropylene wax | 10 | 10 | 10 |
| Polyvinyl butyral resin⁸⁾ | 5 | 0 | 0 |
| Phenoxy resin⁹⁾ | 0 | 5 | 0 |
| Polyester resin¹⁰⁾ | 0 | 0 | 16 |
| Voids | 5.1 | 5.2 | 2.8 |

⁸⁾S-LEC B ® BH-S, SEKISUI CHEMICAL Co., LTD., Mw: 66,000, Tg: 64° C.
⁹⁾PKHH, InChem Corporation, Mw: 52,000, Tg: 92° C.
¹⁰⁾Nichigo-POLYESTER ® TP249, Nippon Synthetic Chemical Industry Co., Ltd., Mw: 16,000, Tg: 36° C.

What is claimed is:

1. An electric component comprising a main body, a terminal electrode on at least one side of the main body and a hot-melt polymer layer on the terminal electrode, wherein the hot-melt polymer layer comprises a metal powder, a polymer and a wax.

2. The electric component of claim 1, wherein the hot-melt polymer layer is 1 to 30 μm thick.

3. The electric component of claim 1, wherein the metal powder is selected from the group consisting of silver, copper, gold, palladium, platinum, rhodium, nickel, aluminum, gallium, indium, tin, zinc, bismuth and a mixture thereof.

4. The electric component of claim 1, wherein glass transition point (Tg) of the polymer is −25 to 180° C.

5. The electric component of claim 1, wherein the polymer is selected from the group consisting of ethyl cellulose, polyvinyl butyral resin, phenoxy resin, hydroxypropyl cellulose resin, polyester resin, phenolic resin, epoxy resin, acrylic resin, melamine resin, polyimide resin, polyamide resin, polystyrene resin, butyral resin, polyvinyl alcohol, polyurethane resin, silicone resin and a mixture thereof.

6. The electric component of claim 1, wherein the wax is selected from the group consisting of vegetable wax, animal wax, mineral wax, petroleum wax, synthetic wax and a mixture thereof.

7. The electric component of claim 1, wherein the wax is selected from the group consisting of bayberry wax, candelilla wax, carnauba wax, castor oil, esparto wax, jojoba oil wax, ouricury wax, rice bran wax, soy wax, tallow tree wax, beeswax, wool wax, shellac wax, spermaceti, ceresin wax, montan wax, montan-ester wax, paraffin wax, microcrystalline wax, ozocerite wax, peat wax, paraffin wax, microcrystalline wax, petroleum jelly wax, fischer-tropsch wax, polyethylene wax, polyolefin wax, polypropylene wax, amide wax, fatty acid wax, fatty acid ester wax and a mixture thereof.

8. The electric component of claim 1, wherein the metal powder is 100 parts by weight, the polymer is 0.5 to 20 parts by weight, and the wax is 0.1 to 50 parts by weights.

9. The electric component of claim 1, wherein the electric component is be selected from the group consisting of a resistor, a capacitor, an inductor and a semiconductor chip.

10. A method of manufacturing an electric component comprising steps of:
providing a main body of the electric component comprising a terminal electrode formed on at least one side of the main body;
applying a hot-melt polymer paste on the terminal electrode, wherein the hot-melt polymer paste comprises a metal powder, a polymer, a wax and a solvent; and
drying the applied hot-melt polymer.
